(19) United States
(12) Patent Application Publication
(10) Pub. No.: US 2008/0276703 A1
(43) Pub. Date: Nov. 13, 2008

(54) Volume measurement gauge/device for an arbitrarily shaped container or glass

(76) Inventor: Christopher Lee Holloway, Boulder, CO (US)

Correspondence Address: Christopher L. Holloway, 306 29th Street, Boulder, CO, 80305, US

(21) Appl. No.: 12/079,697

(22) Filed: Mar. 28, 2008

Related U.S. Application Data
(60) Provisional application No. 60/917,116, filed on May 10, 2007.

(51) Int. Cl. G01F 23/00

(52) U.S. Cl. 73/290 R

(57) ABSTRACT

This patent application is associated with the provisional patent application No. 60/917,116 and claims the filing date of May 10, 2007. This patent application is for a device or gauge that is used to measure and determine the volume in a glass or container, as well as determine the amount missing from the container. This device or gauge is designed to be placed on the side of any arbitrarily shaped container or glass in order to determine either the amount of substance (liquid or solid) in the container and/or the amount of substance missing from the container.

### BACKGROUND OF THE INVENTION

This patent application is associated with the provisional patent application No. 60/917,116 and claims the filing date of May 10, 2007. For a variety of reasons and applications it is desirable to measure and determine the amount of substance in a container. This invention relates to the measuring and determining of the amount of substance (liquid or solid) in a container, or missing from a container, or both. The device is shaped in such a manner that it can be placed on the side of a glass or container, and the amount of the contents in the glass or container can be determined.

Various methods for measuring the volumes of substances in different types of containers are well known. The prior art use different approaches than that being claimed in this current patent application, ranging from simplistic to complicated mechanical, electromechanical, electro-optical or electronic devices. For example, U.S. Pat. Nos. 3,881,640 and 3,345,980 illustrate that marks or labels could be placed on the side of the container during the manufacturing of the container. These marks or labels placed on the container by the manufacturer can be read or viewed in order to obtain the amount of liquid in the container. This is the typical approach used in graduated cylinders and beakers, for example, common within the field of chemistry.

Other approaches may be more complicated. For example, there are U.S. Pat. Nos. (6,301,961, 3,548,657, 3,049,922, and 1,524,928) that use mechanical means to re-direct the liquid in the container in order to determine the volume in the container. Other U.S. Pat. Nos. (2,715,337, 3,741,656, 6,067,855, 4,417,472, 5,043,707, and 5,073,720) use mechanical, electromechanical, electro-optical, or electronic devices as a means to measure the liquid, as well as thermo-materials (U.S. Pat. Nos. 6,761,066 and 6,880,396).

The invention described in this current application concerns a portable device or gauge that does not require pre-existing labels on a container, nor does it require complicated mechanical, electromechanical, electro-optical, or electronic equipment. The device or gauge described in this application is simply placed on the side of the container. The device is designed for glasses or containers of various shapes. The shape of the device has the same contour or shape as the exterior of the glass or container, and is designed to be placed on the side of the glass or container to determine either the amount of substance (liquid or solid) in the container or the amount of substance missing from the full container, or both.

### SUMMARY OF THE INVENTION

This invention relates to the measuring and determining of the amount of substance (liquid or solid) in a container or missing from a container. This application is for a portable device or gauge that is used to measure and determine the volume in a glass or container. The device is shaped in such a manner that it can be placed on the side of a glass or container, and the amount of substance (liquid or solid) in the glass or container can be determined. The device is also designed to determine the amount of substance missing from the container. The device is designed for glasses or containers of various shapes. The shape of the device has the same contour or shape as the glass or container and is designed to be placed on the side of the glass or container to determine the volume (or missing volume). The device has markings to indicate the amount of liquid remaining in the container as well as the corresponding amount of liquid missing. The device comes in various sizes and is made of various materials depending on the applications and the container shape.

### BRIEF DESCRIPTION OF THE DRAWINGS

FIG. 1 illustrates the device or gauge for a conical shaped container. The gauge in this figure is an illustration of one example of a gauge or device designed particularly for a container in the shape of a U.S. pint glass, as commonly found in bars and restaurants for dispensing beer or other beverages.

FIG. 2 illustrates the gauge or device that is designed for a U.S. pint glass being used to show that 12 oz. of liquid is in the glass and 25% of the filled volume of liquid is missing.

FIG. 3 illustrates the gauge or device that is designed for a US pint glass being used to show that 14 oz. of liquid is in the glass and 13% of the filled volume of liquid is missing.

FIG. 4 shows the geometry of a conical shaped container, where L is the inside height, Dₜₒₚ is the inside diameter at the top of the container, and D_{bot} is the inside diameter at the bottom of the container.

FIG. 5 shows a curve that indicates the amount of liquid in a conical shaped container as a function of Hₜₒₚ (the distance of the liquid surface from the top of the container).

### DETAILED DESCRIPTION OF THE INVENTION

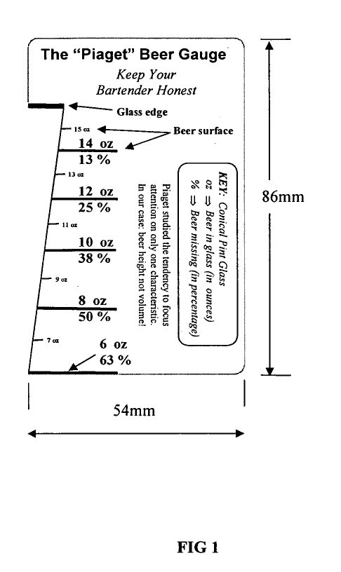

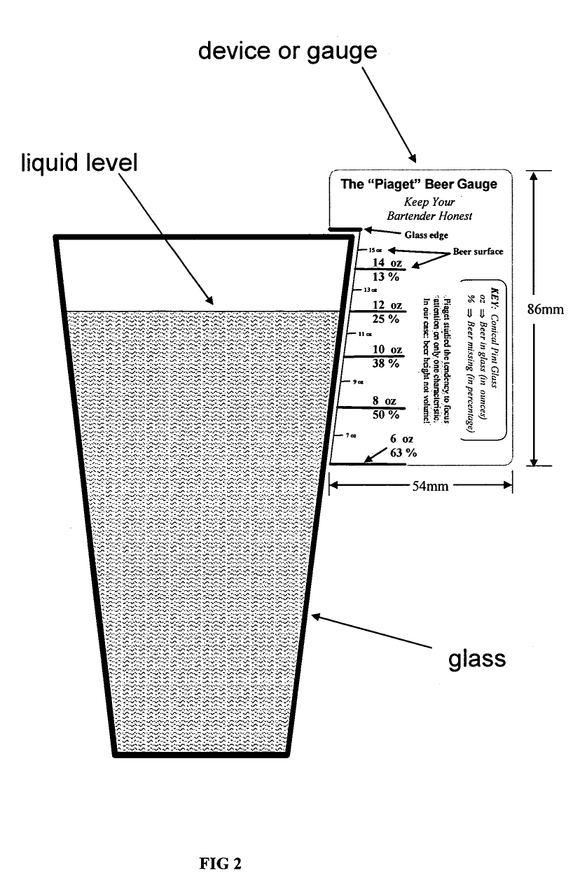

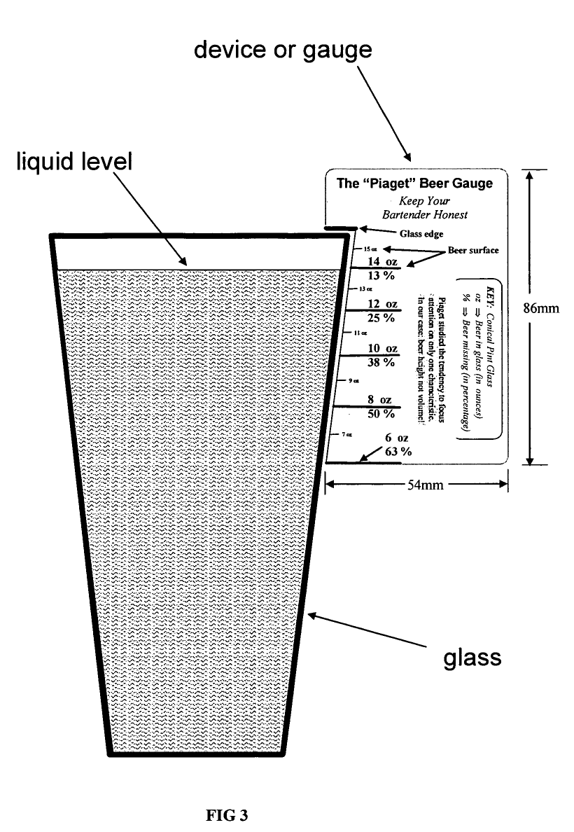

This patent application is associated with the provisional patent application No. 60/917,116 and claims the filing date of May 10, 2007. This application is for a portable device or gauge used to measure and determine the volume in a glass or container. The device is shaped in such a manner that it can be placed on the side of a glass or container, and the amount of substance (liquid or solid) in the glass or container can be determined. The device is also designed to determine the amount of substance missing from the container if it was filled to capacity. The device is designed for glasses or containers of various shapes. The shape of the device has the same contour or shape as the glass or container and is designed to be placed on the side of the glass or container to determine the volume (or missing volume). FIG. 1 illustrates a particular device designed for a conical shaped container (for example, a U.S. pint glass as typically found in bars and restaurants). The device in this figure has markings to indicate the amount of liquid remaining in the container as well as the corresponding amount of liquid missing from the filled container. FIG. 2 and FIG. 3 illustrate how the device would be used. For example, FIG. 2 illustrates the gauge or device that is designed for a U.S. pint glass being used to show that 12 oz. of liquid is in the glass and 25% of the liquid is missing (i.e., 25% of glass's full capacity). FIG. 3 illustrates the gauge or device that is designed for a US pint glass being used to show that 14 oz. of liquid is in the glass and 13% of the liquid is missing (i.e., 13% of glass's full capacity).

The device can be designed for any shaped glass or container. The device is cut in such a manner that the device follows the contour or shape of the glass or container (see FIG. 1 through FIG. 3 for a conical shaped container) such that when the container is on a flat, level surface, said device accurately indicates the volume of the contents (or, equivalently, the volume of contents missing). Once the contour of the glass or container is determined, the marks that indicate the level of the substance in the container are determined either mathematically or by trial and error. Below shows the mathematical determination of a conical shaped U.S. pint glass.

These devices are made from various materials depending on the application. The devices or gauges shown in FIG. 1 through FIG. 3 may be made from a waterproof material, such as plastic or polyvinyl chloride (PVC).

These devices are also designed and manufactured in various sizes depending on the application. For example, the devices shown in FIG. 1 through FIG. 3 are approximately the same size as a credit card and are designed to fit into a pocket, wallet, or handbag.

The device or gauge may be incorporated into other useful items and products. Two examples are; beverage coasters and beverage container openers.

The device or gauge also contains other useful information about the particular shape of the glass or container and/or the substance contained within, such as conversion factors, useful curves, and geometric information (see FIG. 1 through FIG. 3 for a conical shaped US pint glass).

The general device or gauge is designed to be placed on the side of any arbitrarily shaped container or glass in order to determine either the amount of substance in the container or the amount of substance missing from the container. The exact shape and markings on the device will be dictated by the specific shape and incremental volume held within the container.

The exact shape of the container, as well as the reference point indicating where the container is considered full, is arbitrary: the invention may be suitably modified to accommodate various geometric shapes and reference locations on the containment vessel. Thus, the example given is merely representative of how the invention may be implemented.

### Mathematical Derivation for the Conical Shaped US Pint Glass

The standard US pint glass is conical in shape; that is, an inverted truncated cone around six inches tall and tapering by about an inch diameter over the entire height of the glass.

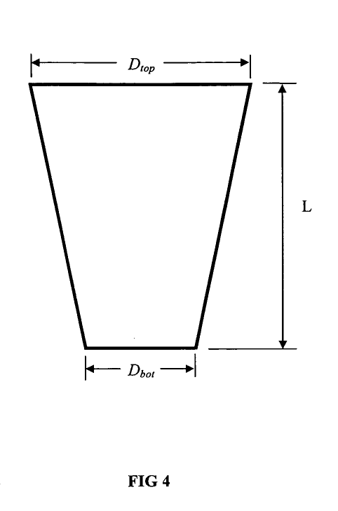

Mathematically speaking, this type of structure is referred to as a conical frustum, which is created by slicing the top off a cone (where the slice is made parallel to the base). This geometric shape is shown in FIG. 4. To determine the volume of this conical frustum (i.e., a pint glass), we could look in a set of mathematical Tables or derive it ourselves. The following is the derivation.

Start by writing the volume as

V=∫dV,

where V is the total volume of the pint glass and dV is the differential volume element. We next realize that since the pint glass is cylindrical in shape we can use the cylindrical coordinate system to derive the needed volume. Hence, in cylindrical coordinates, the differential volume element is expressed as

dV=dφρdρdz,

and the volume is expressed as

V=∫∫∫dφρdρdz.

Now we must determine the limits of integrating. The limits of dz and dφ are very straight forward. The limits for dz are 0 to L (the inside length of the glass), and the limit for dφ are 0 to 2π. We have to be careful with the limits on ρ. As the height of the beer in the glass increases, the radius of the beer surface increases. The radius for a given height “z” is given by

$${ρ}_{z} = \frac{1}{2} [ {D}_{bot} + \frac{z}{L} ( {D}_{top} - {D}_{bot} ) ] .$$

Thus, the limit of the ρ integral will be 0 to ρ_{z}. With the limits of integration determined, the volume is given

$$V = {\int }_{0}^{2 π} d φ {\int }_{0}^{L} [ {\int }_{0}^{{ρ}_{z}} ρ d ρ ] d z .$$

The dφ integral is elementary to evaluate, which we can do first to give

$$V = 2 π {\int }_{0}^{L} [ {\int }_{0}^{{ρ}_{z}} ρ d ρ ] d z .$$

Since ρ_{z} is a function of z, we having to be careful about the order of integration of the remaining integrals. We evaluate dρ first to give

$$V = \frac{π}{4} {\int }_{0}^{L} {[ {D}_{bot} + \frac{z}{L} ( {D}_{top} - {D}_{bot} ) ]}^{2} d z .$$

This integral is very straightforward to evaluate, and after all the dust clears we have the following for the volume of the pint glass

$$V = \frac{π}{12} L [ {D}_{bot}^{2} + {D}_{top}^{2} + {D}_{bot} {D}_{top} ] .$$

The volume for any height (between 0 and L) of liquid in the glass is given

$$V = \frac{π}{12} ( L - {H}_{top} ) [ {D}_{bot}^{2} + {D}_{H}^{2} + {D}_{bot} {D}_{H} ] ,$$

where Hₜₒₚ is the distance from the surface of the liquid to the top of the pint glass, and D_{H} is the diameter of the liquid surface at the Hₜₒₚ location. This is the equation used to determine the markings on the device or gauge indicating the volume in the container.

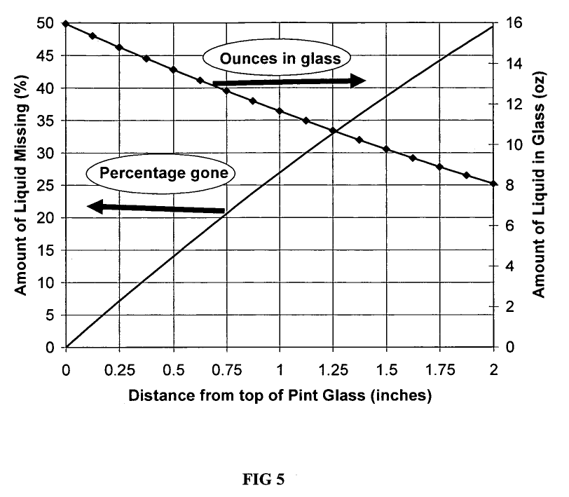

We can now use this equation to plot a graph that shows the amount of liquid in a standard pint glass as a function of the distance Hₜₒₚ (the distance of the liquid surface from the top of the pint glass). This plot is shown in FIG. 5. Also shown in this figure is the amount of liquid missing as a function of Hₜₒₚ.

This figure shows that if a liquid is poured to a distance of ½ inch from the top, less than 14 oz are in the glass and 13% of the liquid is GONE. A distance of less than 1 inch from the top of the glass occupies 25% of the liquid and less then 12 oz are in the glass. At a distance of 2 inches from the top, 8 oz of liquid are in the glass and 50% of the liquid is GONE.

What is claimed is:

1. A portable hand-held device or gauge for determining and displaying the volume of liquid or solid in a specific but arbitrarily-shaped container comprising:
a substrate marked thereon with volume indications;
a reference locator or indicator appropriate for said container for correct positioning thereon;
a reference indicator for indication of the appropriate filled volume of said container;

2. The invention of claim 1, wherein said specific but arbitrarily-shaped container is a conical frustum.

3. The invention of claim 1, wherein said specific but arbitrarily-shaped container is a conventional wine glass for use with a specific type of wine.

4. The invention of claim 1, wherein said specific but arbitrarily-shaped container is a conventional beer glass for use with a specific type of beer.

5. The invention of claim 1, in combination with marks or indicators for determining and displaying the volume of liquid or solid absent from said container relative to said filled volume reference indication.

6. The invention of claim 1, in combination with further diagrams, drawings, or similar information describing the shape of the intended container for which said device or gauge is intended to be used.

7. The invention of claim 1, in combination with further marks, graphs, curves, or similar information describing or depicting the relationship between the level of contents within said container and the volume thereof relative to either said reference mark indicating the maximum volume point or relative to the empty state of said container.

8. The invention of claim 1, wherein said substrate is approximately the size and thickness of a conventional wallet-sized credit card.

9. The invention of claim 1, in various sizes and made of various materials depending on the applications and the container shape.

10. The invention of claim 1, incorporated into beverage coasters.

11. The invention of claim 1, incorporated into beverage container openers.

12. The invention of claim 1, incorporated into other useful items and products.
